(19) United States
(12) Patent Application Publication
(10) Pub. No.: US 2010/0223634 A1
(43) Pub. Date: Sep. 2, 2010

(54) OPTICAL DISC APPARATUS

(76) Inventors: Takayuki FUJIMOTO, Tsuchiura (JP); Makoto Ibe, Hitachinaka (JP); Seiji Hamaie, Kawasaki (JP); Nozomu Harada, Kawasaki (JP); Shinya Asano, Tokyo (JP); Yoshiaki Yamauchi, Omitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/709,175

(22) Filed: Feb. 19, 2010

(30) Foreign Application Priority Data
Feb. 27, 2009 (JP) 2009-045040

(51) Int. Cl. G11B 17/04

(52) U.S. Cl. 720/601; G9B/17.013

(57) ABSTRACT

An optical disc apparatus comprises the followings within housing thereof: an optical pickup, which is configured to conduct recording or reproducing of a disc, as an information recording medium; a rotation mechanism of said disc; a transfer mechanism, which is configured to move said optical pickup from an inner periphery of said disc up to an outer periphery thereof; a mechanical chassis, which is configured to mount said optical pickup, said disc rotation mechanism and said transfer mechanism thereon; a disc tray, which is configured to conduct storing and taking out of said disc; and a connector, which is configured to electrically connect between a circuit board for conducting driving control of said rotation mechanism and an external electronic apparatus, wherein a projection portion is provided on a reverse surface of said disc tray, at a portion facing to said connector at a position when said disc tray is stored, to be inserted into a gap between periphery of said connector and said housing, and thereby preventing fluid sounds (or wind sounds) generating due to high-speed rotation of the disc when high-speed recording/reproducing, from leaking into an outside of the apparatus, so as to reduce the noises therefrom.

This application relates to and claims priority from Japanese Patent Application No. 2009-045040 filed on Feb. 27, 2009, the entire disclosure of which is incorporated herein by reference.

### BACKGROUND OF THE INVENTION

The present invention relates to an optical disc apparatus (or, an optical disc drive) for performing recording and reproduction of information, under the condition of rotating an orbicular disc.

An optical disc is a data memory device for recording data on a disc surface thereof, and is also that for reproducing data recorded on a disc surface, as well, under the condition of rotating a data recording medium, i.e., the orbicular disc. An optical element (i.e., an optical head) to be applied as a signal writing/reading means for recording/reproducing of data, comprising a semiconductor laser element and a laser receiving portion, etc., therein, is called by an optical pickup, or simply, a pickup.

As the discs, i.e., the data recording media, there can be listed up the followings; such as, CD-ROM, CR-R, CD-RW, DVD-ROM, DVD-R, DVD-RW, DVD-RAM, DVD+R, DVD+RW, BD-ROM, BD-R, and BD-RE, etc., for example. And an optical disc apparatus, in general, is mounted on electronic equipment, for example, a personal computer (PC) or the like, comprising a central processing unit (e.g., CPU) for conducing an access control to the optical disc apparatus and calculation process, etc. In case when the electronic equipment mentioned above is a desk-top type PC, that optical disc apparatus is called, in general, a half-height type optical disc apparatus, and in case when it is a notebook type PC, it is called, in general, a slim-type optical disc apparatus.

Among those, for the slim-type optical disc apparatus, in particular, it is required to be silent, in particular, when it records/reproduces at high speed, as well as, to be large in the data memory capacity thereof, high-speed of the speed when recording/reproducing data. As a noise source when recording/reproducing data is mainly fluid sounds (wind noises) accompanying with high-speed rotation of the disc.

On the other hand, it is also necessary to reduce leakage of sounds, by interrupting a route for the fluid sounds generating within the disc apparatus to propagate to an outside of the apparatus. In case of the slim-type optical disc apparatus, the rotation speed of the disc is about 90 Hz (corresponding to 24-speed of CD) at the fastest, and for the purpose of dealing with or enabling the further high-speed recording in future, it is important to reduce the leakage of sounds, much more than before.

As a measure for muffling, for example, in the following Patent Document 1 is proposed a method for reducing the fluid sounds (wind sounds), with provision of an air opening so as to discharge an airflow under a lower surface of the disc from that air opening.

### PRIOR ART DOCUMENTS

### Patent Documents

[Patent Document 1] Japanese Patent Laying-Open No. 2001-43613 (2001).

### BRIEF SUMMARY OF THE INVENTION

Within the slim-type optical disc apparatus, there is a problem that the noises are increased due to the leakage of the fluid sounds (wind sounds) into an outside of the apparatus, which are generated by the high-speed rotation of the disc when conducting the high-speed recording/reproducing.

An object of the present invention is to provide an optical disc apparatus for enabling to prevent the noises from being generated, in particular, due to leakage of the fluid sounds (wind sounds) into the outside of the apparatus.

The object mentioned above is accomplished by an optical disc apparatus, comprising the followings within housing thereof: an optical pickup, which is configured to conduct recording or reproducing of a disc, as an information recording medium; a rotation mechanism of said disc; a transfer mechanism, which is configured to move said optical pickup from an inner periphery of said disc up to an outer periphery thereof; a mechanical chassis, which is configured to mount said optical pickup, said disc rotation mechanism and said transfer mechanism thereon; a disc tray, which is configured to conduct storing and taking out of said disc; and a connector, which is configured to electrically connect between a circuit board for conducting driving control of said rotation mechanism and an external electronic apparatus, wherein a projection portion is provided on a reverse surface of said disc tray, at a portion facing to said connector at a position when said disc tray is stored, to be inserted into a gap between periphery of said connector and said housing.

Also, the object mentioned above is also accomplished by the optical disc apparatus, as is described in the above, wherein said projection portion is inserted into the gaps defined between an upper surface and a side surface of said connector and said housing.

Also, the object mentioned above is also accomplished by the optical disc apparatus, as is described in the above, wherein said projection portion is inserted only into the gap defined between an upper surface and said housing.

Also, the object mentioned above is also accomplished by the optical disc apparatus, as is described in the above, wherein said projection portion is inserted only into the gap defined between a side surface and said housing.

Also, the object mentioned above is also accomplished by the optical disc apparatus, as is described in the above, wherein a cutout portion is provided penetrating to said disc tray at position facing to said connector, in position where said disc tray is stored.

Also, the object mentioned above is also accomplished by the optical disc apparatus, as is described in the above, wherein a cutout surface defining said cutout portion is inclined with respect to a surface facing to said connector.

According to the present invention, it is possible to provide an optical disc apparatus for enabling to prevent the noises from being generated due to the leakage of the fluid sounds (wind sounds) into the outside of the apparatus.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for briefly showing the interior structure of an optical disc apparatus, applying a first embodiment therein;

FIG. 2 is also a perspective view for briefly showing the interior structure of the optical disc apparatus, applying the first embodiment therein;

FIGS. 3A and 3B are perspective views for showing a bottom plate cover within the optical disc apparatus, applying the embodiment of the present invention therein;

FIG. 4 is a perspective view for showing a disc tray within the optical disc apparatus, applying the embodiment of the present invention therein;

FIG. 5 is also a perspective view for showing the disc tray within the optical disc apparatus, applying the embodiment of the present invention therein;

FIG. 6 is an explanatory view for showing a rough structure on periphery of a connector within the optical disc apparatus, applying the first embodiment therein;

FIGS. 7A and 7B are perspective views including a cross-section view for showing a rough structure on periphery of the connector within the optical disc apparatus, applying the first embodiment therein;

FIG. 8 is an explanatory view for showing a result of noise measurement of the optical disc apparatus, applying the first embodiment therein;

FIGS. 9A and 9B are perspective views for showing the structure of the disc tray within the optical disc apparatus, applying the first embodiment therein;

FIG. 10 is a perspective views for showing the structure of the disc tray within the optical disc apparatus, applying a second embodiment therein;

FIG. 11 is also a perspective views for showing the structure of the disc tray within the optical disc apparatus, applying the second embodiment therein;

FIG. 12 is an explanatory view for showing a rough structure on periphery of a connector within the optical disc apparatus, applying the second embodiment therein;

FIGS. 13A and 13B are perspective views including a cross-section view for showing a rough structure on periphery of the connector within the optical disc apparatus, applying the second embodiment therein;

FIG. 14 is an explanatory view for showing airflow on periphery of the connector within the optical disc apparatus, applying the second embodiment therein;

FIG. 15 is an explanatory view for showing a result of noise measurement of the optical disc apparatus, applying the second embodiment therein;

FIGS. 16A and 16B are perspective views including a cross-section view for showing a rough structure on periphery of the connector within the optical disc apparatus, applying the second embodiment therein; and

FIG. 17 is a perspective views for showing the structure of the disc tray within the optical disc apparatus, applying the second embodiment therein;

### DETAILED DESCRIPTION OF THE PREFERRED EMBODIMENTS

Hereinafter, embodiments according to the present invention will be fully explained by referring to the attached drawings.

### Embodiment 1

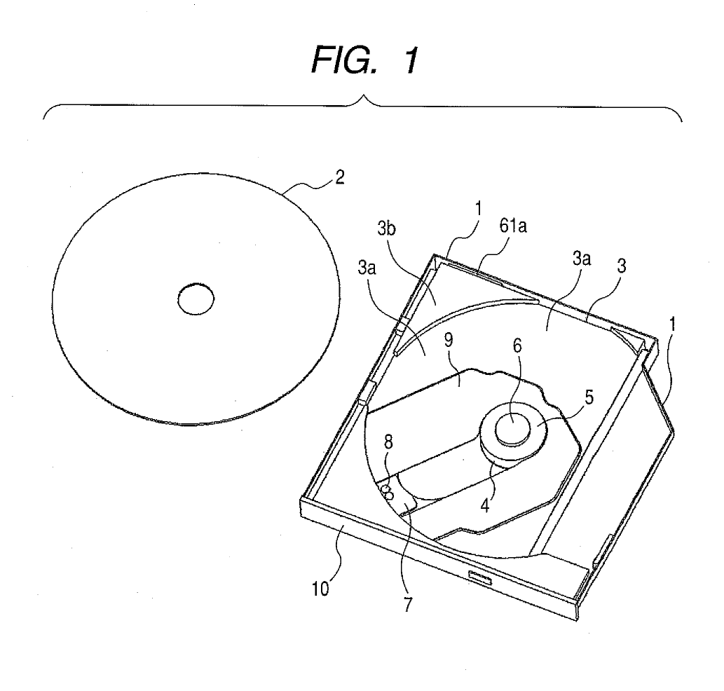

FIG. 1 attached herewith is a perspective view for briefly showing the internal structure of an optical disc apparatus according to a first embodiment.

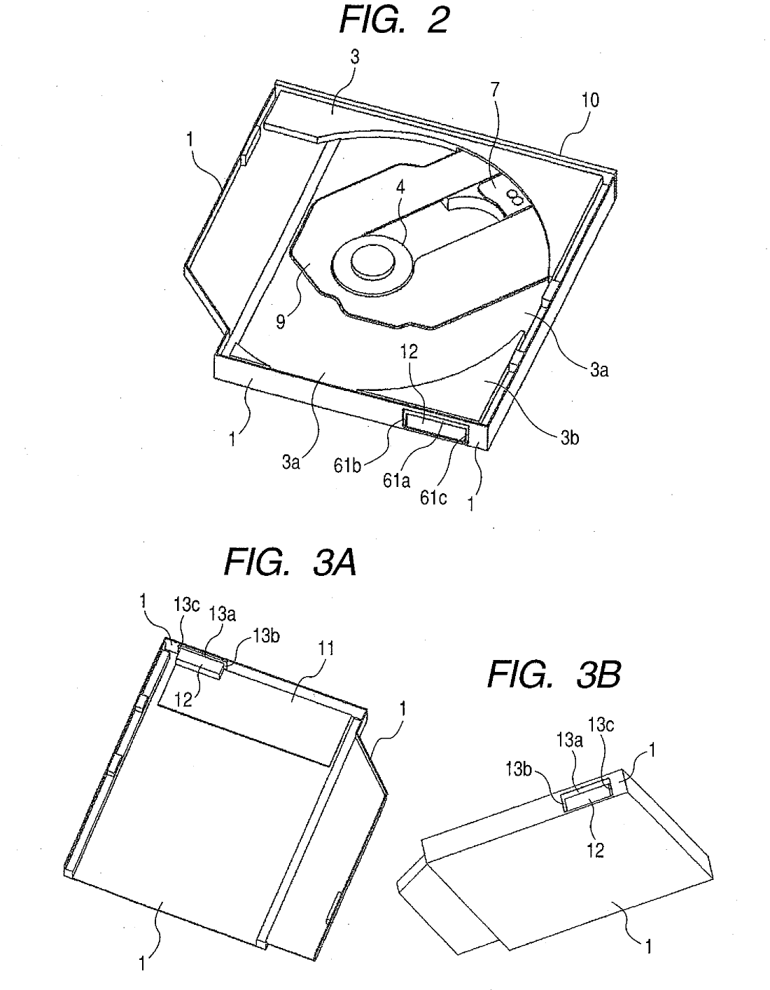

FIG. 2 is a perspective view for showing the optical disc apparatus shown in FIG. 1, but seeing it from the behind thereof. However, in those FIGS. 1 and 2, a top plate cover of the optical disc apparatus is omitted therefrom.

In those FIGS. 1 and 2, a disc 2 can be inserted (or, loaded) or taken out (or ejected) into/from an inside of the apparatus by moving a disc tray 3, for mounting the disc 2 thereon, on a guide, which is provided within the apparatus (not shown in the figure).

FIG. 1 shows the condition where the disc tray 3 is stored within a bottom plate cover 1 (i.e., a housing of the apparatus). When the disc 2 is loaded on the disc tray 3, the disc 2 is mounted on a turntable 5 of a spindle motor 4 for use of rotation drive of the disc, and it is fixed by means of a disc chuck 6. And, with rotational driving of the spindle motor 4, the disc 2 rotates. Under the condition of rotating the disc 2, the optical pickup 7 is moved from an inner periphery of the disc 2 to an outer periphery thereof, by means of a transfer mechanism (not shown in the figure). In this instance, a laser light oscillating from a laser element, which is installed within the optical pickup 7, is irradiated upon a recording layer of the disc 2, passing through an optical unit from an objective lens 8, and thereby conducting the recording of data on the disc 2.

On the other hand, when reproducing the data recorded on the disc 2, a reflection light from the disc 2 passes through the optical unit from the objective lens 8, and it is detected upon a laser receiver portion. Between the optical pickup 7 and the disc 2 is provided a decorative laminate 9 covering the optical pickup 7 other than the periphery thereof. The transfer mechanism or the like, for the optical pickup 7 and the spindle motor 4, is mounted on a structural member, being called a “mechanism chassis”, in general. Because the mechanical chassis is provided below the decorative laminate 9, it is omitted herein. Also, a front surface of the disc tray 3 is called a “front bezel” 10, in general.

FIGS. 3A and 3B are perspective views of the bottom plate cover 1.

FIGS. 3A and 3B show the disc apparatus therein, which was shown in FIGS. 1 and 2, but under the condition of taking out the disc tray 3, the decorative laminate 9, the optical pickup 7, the spindle motor 4 and the mechanical chassis therefrom; i.e., aligning views seeing the bottom plate cover 1 from the reverse surface side thereof.

In FIGS. 3A and 3B, on the bottom plate cover 1 is mounted a circuit board 11 for use of disc apparatus control, and on the circuit board 11 is attached a connector 12. Through this connector 12, an electronic apparatus (for example, PC) having a central processing apparatus for conducting accessing control to the disc apparatus and calculation process, etc., is electrically connected with the disc apparatus.

The connector 12 is positioned below a flat surface 3b (shown in FIG. 1 and FIG. 2) rising up in convex-like manner to a flat surface 3a, in an area or region on periphery of the almost circular flat surface 3a (shown in FIGS. 1 and 2) of the disc tray 3, facing to a recording/reproducing surface of the disc 2, when the disc tray 3 is stored into the disc apparatus. Also, between an upper surface of the connector 12 and the bottom plate cover 1 and between a side surface of the connector 12 and the bottom plate cover 1 are formed gaps (clearances) 13a, 13b and 13c, for the purpose of preventing an interference between both, when the electronic apparatus mounting the disc apparatus is electrically connected with the disc apparatus.

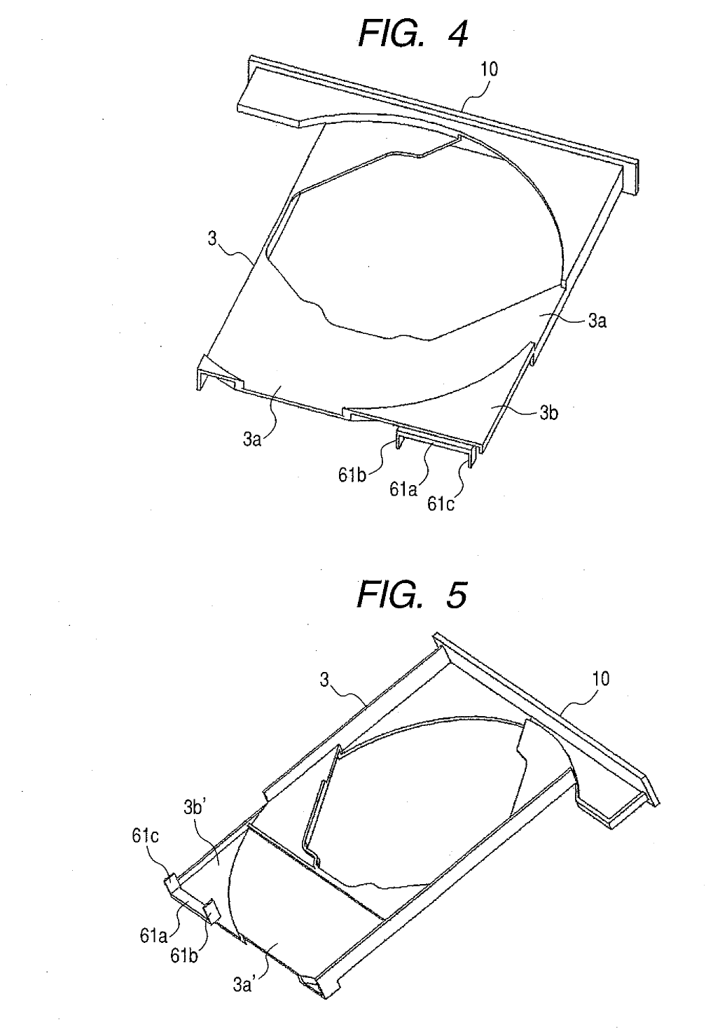

FIGS. 4 and 5 show the perspective view of the disc tray 3 to be applied in the present embodiment.

FIG. 4 is the perspective view of the disc tray 3 when seeing it from a front surface side thereof (i.e., a side surface facing to the recording/reproducing surface of the disc 2). FIG. 5 is the perspective view of the disc tray 3 when seeing it from a reverse surface side thereof.

In FIG. 4 and FIG. 5, on a reverse surface 3b′ of the flat surface 3b of the disc tray 3, at the position facing to the connector 12 shown in FIG. 3 when storing the disc tray 3 therein, there are provided a projection portion 61a nearly fitting or inserting into the gap defined between an upper surface of the connector 12 and the bottom plate cover 1, and projection portions 61b and 61c nearly fitting or inserting into the gap defined between a side surface of the connector 12 and the bottom plate cover 1.

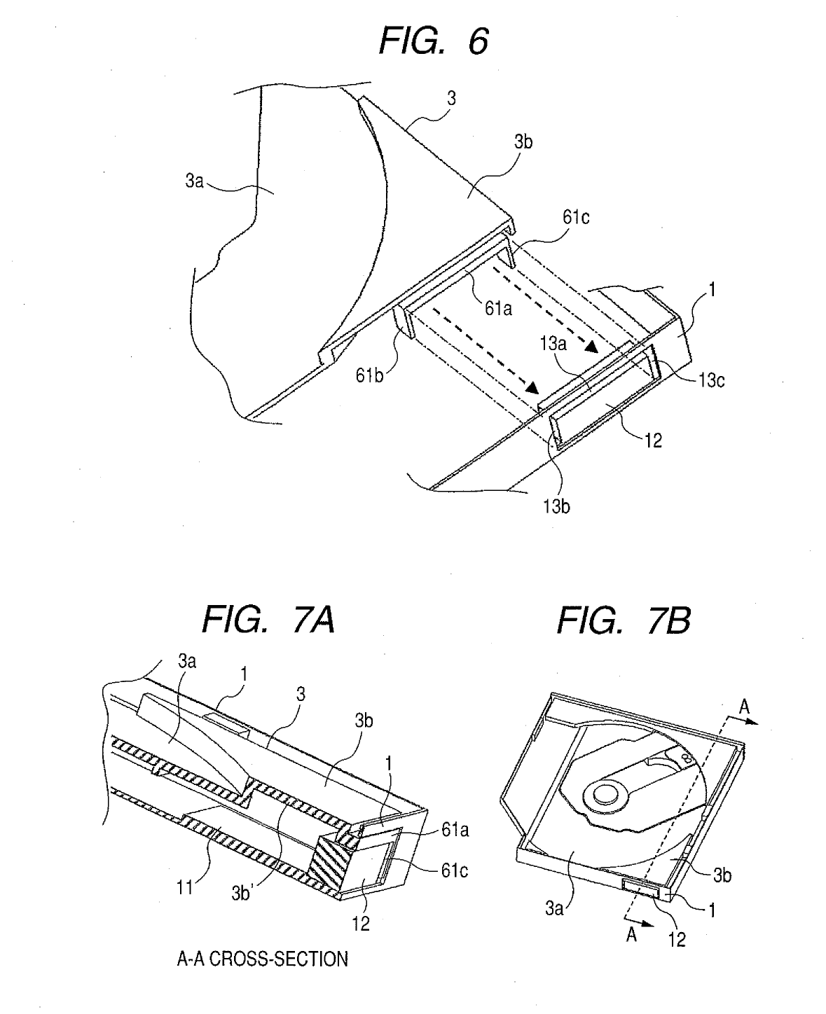

FIG. 6 and FIGS. 7A and 7B are brief structural views of portions on periphery of the connector 12 of the disc apparatus, and in particular, FIG. 7A is the vertical cross-section view including the connector 12 therein, along an A-A line in FIG. 7B.

In FIG. 6 and FIGS. 7A and 7B, when storing the disc tray 3 into the apparatus (storing into a direction of an arrow of dotted line in FIG. 6), the projection portions 61a, 61b and 61c cover the upper surface and the side surface of the connector 12; therefore, the gaps 13a, 13b and 13c between the connector 12 and the bottom plate cover 1 are almost closed or blocked.

As was mentioned above, with the first embodiment, as is shown in FIGS. 7A and 7B, the projection portions 61a, 61b and 61c on the reverse surface 3b′ of the disc tray 3 cover the periphery of the connector 12, and also the gaps 13a, 13b and 13c between the connector 12 and the housing of the disc apparatus; therefore, it is possible to achieve silencing due to reduction of the leakage of sounds.

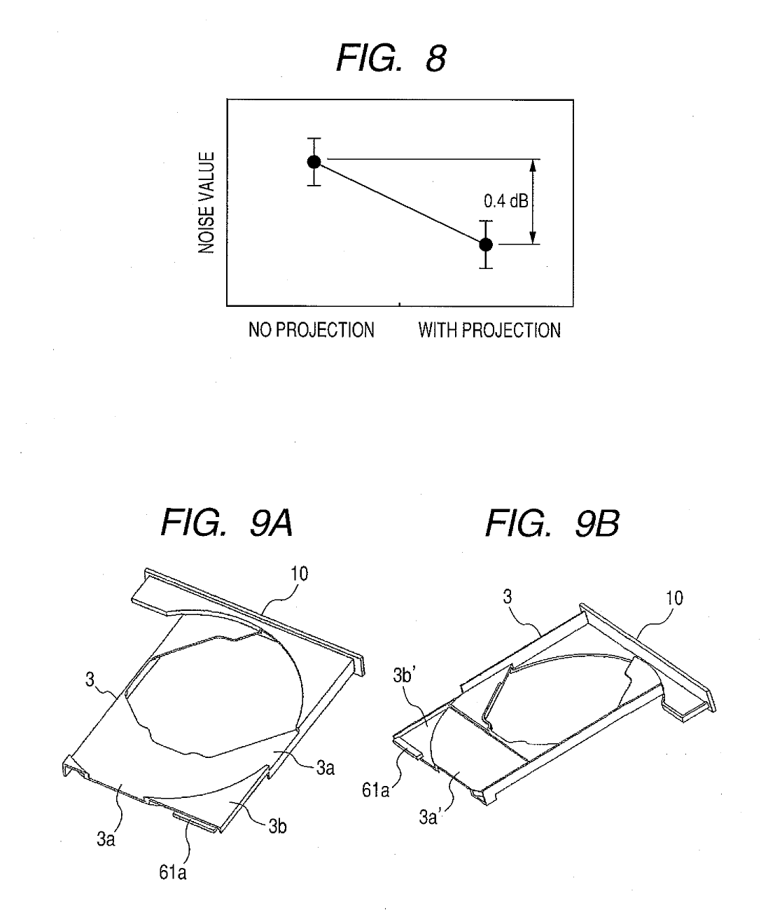

FIG. 8 is a graph for showing a result of noise measurement, in case where the projection portions 61a, 61b and 61c are provided or not.

In FIG. 8, it is a result of measurement from behind the disc apparatus, when rotating the disc at about 90 Hz (corresponding to 24-speed of CD). With provision of the projection portions 61a, 61b and 61c, it is confirmed that a noise value is reduced by 0.4 dB.

Further, in the present embodiment, the projection portions 61a, 61b and 61c on the reverse surface 3b′ of the disc tray 3 may be provided only with the projection portion 61a, as is shown in FIGS. 9A and 9B, for example. In this instance, when the disc tray 3 is stored in the disc apparatus, since the projection portion 61a is nearly fitting or inserting into the gap 13a between the upper surface of the connector 12 and the bottom plate cover 1, so as to block or close the gap 13a between the upper surface of the connector 12 and the bottom plate cover 1, then it is possible to achieve silencing due to reduction of the leakage of sounds. Also, the projection portions 61a, 61b and 61c on the reverse surface 3b′ of the disc tray 3 may be provided with the projection portions 61b and 61c, or with the projection portions 61a and 61b, or with the projection portions 61a and 61c, or alternatively, with either one of the projection portions 61b and 61c.

### Embodiment 2

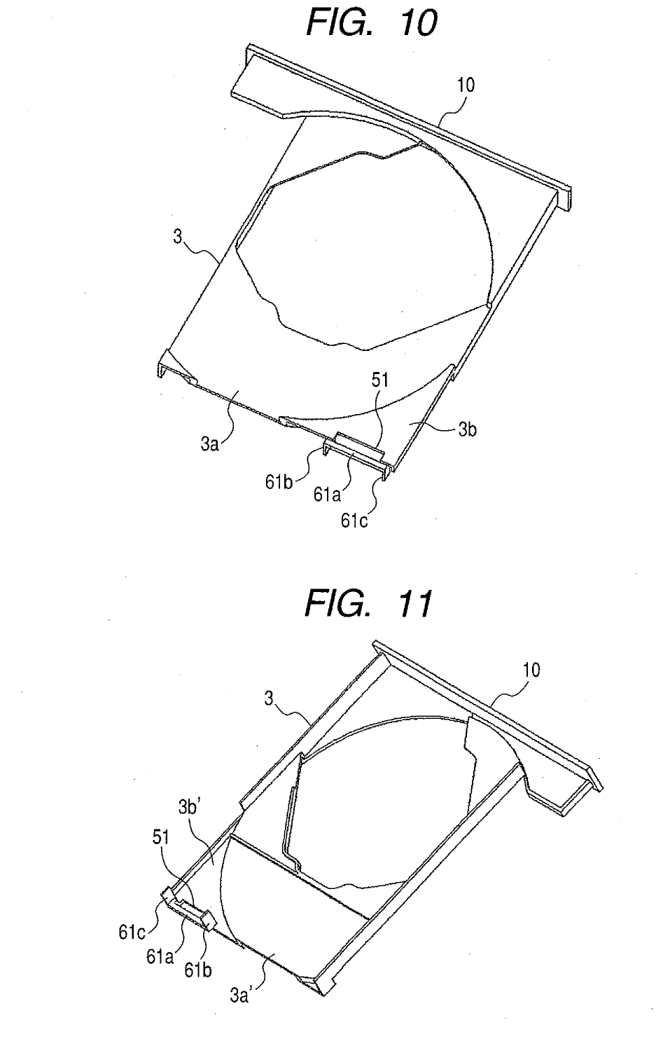

In FIG. 10 and FIG. 11 is shown the perspective view of the disc tray to be applied in a second embodiment.

FIG. 10 is the perspective view of the disc tray 3, when seeing it from a front surface side thereof (a surface side facing to the recording/reproducing surface of the disc 2).

FIG. 11 is the perspective view of the disc tray 3, when seeing it from a reverse surface side thereof.

In FIG. 10 and FIG. 11, in the periphery area or region of the flat surface 3a of the disc tray 3, being almost circular in the shape thereof, facing to the recording/reproducing surface of the disc 2, on the flat surface 3b rising up in convex-like manner to the flat surface 3a, according to the present embodiment, a cutout portion 51 is provided at the position facing to the connector 12 when storing the disc tray 3 therein. Further, similar to the first embodiment, in the periphery area or region of the almost circular flat surface 3a of the disc tray 3 facing to the recording/reproducing surface of the disc 2, on the reverse surface 3′ of the flat surface 3b rising up in convex-like manner to the flat surface 3a, at the position facing to the connector 12 when storing the disc tray 3 therein, there are provided the projection portions 61a, 61b and 61c, nearly fitting or inserting into the gaps defined among the upper surface and the side surface of the connector 12 and the bottom plate cover 1. In this instance, the cutout portion 51 is positioned on the disc side rather than the projection portions 61a, 61b and 61c.

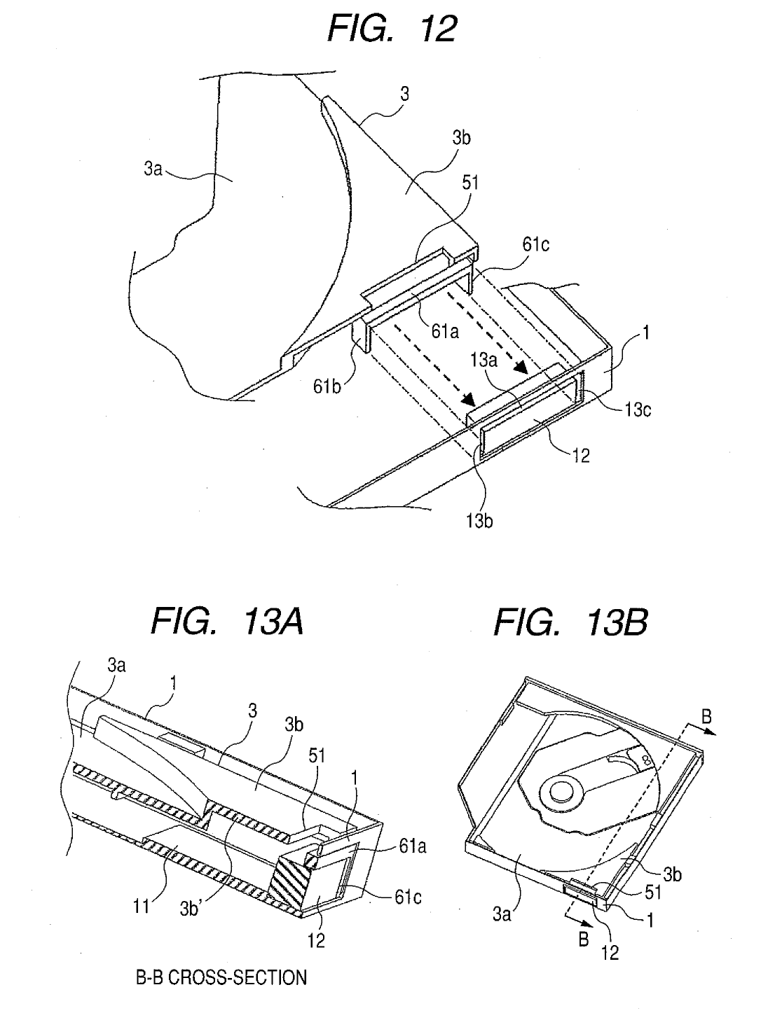

FIG. 12 and FIGS. 13A and 13B are brief structural views of portions on periphery of the connector 12. In particular, FIG. 13A is the vertical cross-section view including the connector 12 therein, along a B-B line in FIG. 13B.

In FIG. 12 and FIGS. 13A and 13B, when storing the disc tray into the apparatus (storing into a direction of an arrow of dotted line in FIG. 12), the projection portions 61a, 61b and 61c cover the periphery of the connector 12; therefore, the gaps 13a, 13b and 13c between the connector 12 and the bottom plate cover 1 are blocked. In this instance, the cutout portion 51 is positioned on the disc side rather than the projection portions 61a, 61b and 61c.

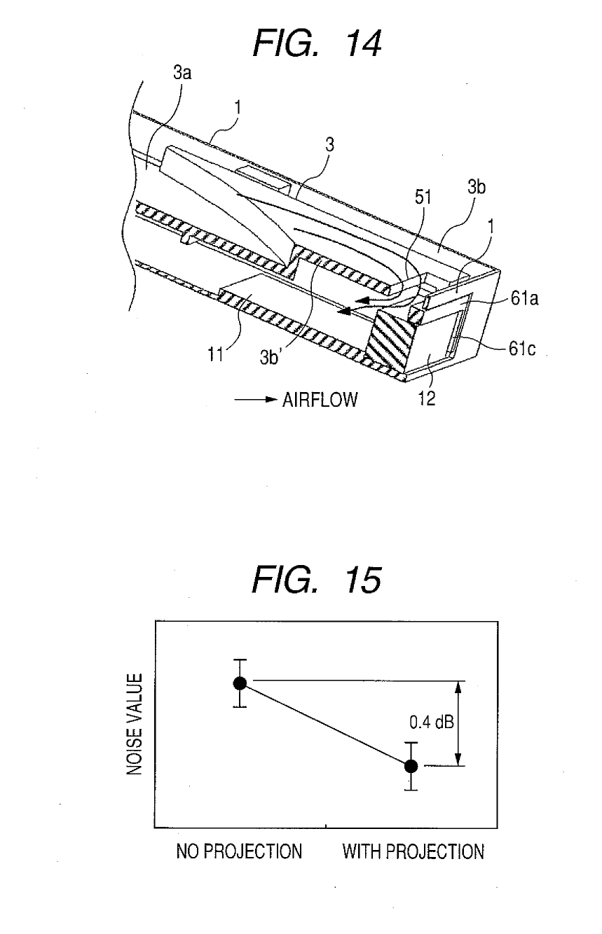

FIG. 14 is a block diagram for showing a manner of the airflow on the periphery of the connector 12.

In FIG. 14, with provision of the cutout portion 51 of the flat surface 3b of the disc tray 3 at the position facing to the connector 12, the gap between the disc tray 3 and the bottom plate cover 1 is widen, so that the airflow generating due to the disc rotation can flows into a reverse surface of the disc tray 3 from the cutout portion 51, without disturbance. With doing so, it is possible to lighten the disturbance of the flow on the periphery of the connector 12, and also reduce the fluid sounds (wind sounds).

FIG. 15 is a graph for showing a result of noise measurement in case where cutout portion 51 is provided and in case where no such cutout portion is provided.

In FIG. 15, it is the result of measuring the noises from behind the disc apparatus when the disc is rotated at about 90 Hz (corresponding to 24-speed of CD). With provision of the cutout portion 51, it is confirmed that the noise value is reduced by 0.4 dB. In this manner, the position where the cutout portion 51 be provided should be, preferably, on the side behind the flat surface 3b of the disc tray 3.

As was mentioned above, according to the second embodiment, since the gap between the disc tray 3 and the bottom plate cover 1 is widen by the cutout portion 51, and the airflow can flows into the reverse surface of the disc tray 3 from the cutout portion 51, without disturbance, the fluid sounds (wind sounds) is reduced. Further, the projection portions 61a, 61b and 61c on the reverse surface 3b′ of the disc tray 3 cover the periphery of the connector 12, and thereby blocking the gaps 13a, 13b and 13c between the connector 12 and the apparatus housing; then it is possible to achieve silencing due to reduction of the leakage of sounds.

However, in the present embodiment, a vertical cross-section configuration of the cutout portion 51, which is provided on the flat surface 3b may be, not only perpendicular to that flat surface 3b, but also inclined with respect to that.

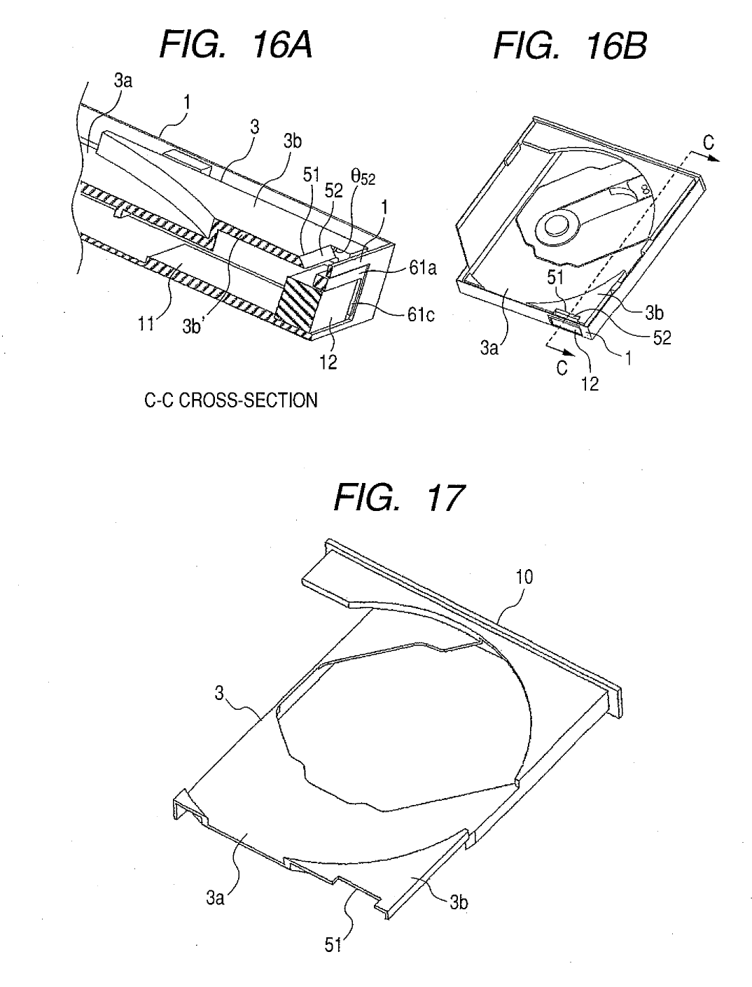

Thus, as is shown in FIGS. 16A and 16B, an angle θ₅₂ defined between the cutout surface 52 of the cutout portion 51 and the flat surface 3b of the disc tray 3 may be smaller than 90°. With doing so, the airflow can flow into the reverse surface of the disc tray 3 from the cutout portion 51, smoothly, and it is possible to reduce the fluid sounds (wind sounds).

Also, in the present embodiment, the projection portions 61a, 61b and 61c on the reverse surface 3b′ of the disc tray 3 may be provided only with the projection portion 61a. In this instance, when the disc tray 3 is stored in the disc apparatus, since the projection portion 61a is nearly fitting or inserting into the gap 13a between the upper surface of the connector 12 and the bottom plate cover 1, so as to block or close the gap 13a between the upper surface of the connector 12 and the bottom plate cover 1, then it is possible to achieve silencing due to reduction of the leakage of sounds. Also, the projection portions 61a, 61b and 61c on the reverse surface 3b′ of the disc tray 3 may be provided with the projection portions 61b and 61c, or with the projection portions 61a and 61b, or with the projection portions 61a and 61c, or alternatively, with either one of the projection portions 61b and 61c.

Also, in the present embodiment, as is shown in FIG. 17, it is sufficient that there is only provided the cutout portion 51, which should be on the flat surface 3b, but without forming the projection portions 61a, 61b and 61c on the reverse surface 3b′ of the disc tray 3. In this case, also the vertical cross-section configuration of the cutout portion 51, which is provided on the flat surface 3b may be, not only perpendicular to that flat surface 3b, but also inclined with respect to that.

As the electronic apparatus, on which the optical disc apparatus according to the first or the second embodiment is mounted, it may be included, not only the notebook-type personal computer (PC), but also a hard disk (HDD) recorder, a DVD recorder, an on-vehicle computer, such as, a navigation system, etc., or a camera and a game machine, etc., mounting the optical disc apparatus thereon.

With the present invention, as was mentioned above, in the optical disc apparatus (the slim-type optical disc apparatus) having a disc tray for use of mounting a disc thereon, and a connector for electrically connecting between an electronic apparatus (for example, PC), mounting the optical disc apparatus thereon, and the optical disc apparatus, the projection portions are provided at the position facing to the connector mentioned above when storing the disc tray, to be nearly fitted or inserted into the gap defined between the periphery of the connector and the housing of the apparatus, and the projection portions on the reverse surface of the disc tray cover the periphery of the connector mentioned above, so that they block or close the gap defined between the connector and the housing of the disc apparatus; therefore, it is possible to achieve silencing due to reduction of the leakage of sounds.

Also in the optical disc apparatus (the slim-type optical disc apparatus) having a disc tray for use of mounting a disc thereon, and a connector for electrically connecting between an electronic apparatus (for example, PC), mounting the optical disc apparatus thereon, and the optical disc apparatus, the cutout portion is provided at the position facing to connector mentioned above when storing the disc tray, on the disc tray, the gap is widen between the disc tray and the housing of the disc apparatus, when storing the disc tray within the disc apparatus, and the airflow generating due to the disc rotation can flow into the reverse surface of the discs tray from the cutout portion, without disturbance, and thereby reducing the fluid sounds (wind sounds).

According to the present invention, it is possible to prevent the fluid sounds (wind sounds) generated accompanying the disc rotation when conducting the high-speed recording/reproducing, from leaking out from the periphery of the connector for electrically connecting between the electronic apparatus mounting the disc apparatus therein and the disc apparatus, and therefore it is possible to achieve the silencing. Also, since it is possible to reduce the fluid sounds (wind sounds) generating on the periphery of the connector for electrically connecting the between the electronic apparatus mounting the disc apparatus therein and the disc apparatus, when conducting the high-speed recording/reproducing, then it is possible to achieve the silencing.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disc apparatus, comprising the followings within housing thereof:
an optical pickup, which is configured to conduct recording or reproducing of a disc, as an information recording medium;
a rotation mechanism of said disc;
a transfer mechanism, which is configured to move said optical pickup from an inner periphery of said disc up to an outer periphery thereof;
a mechanical chassis, which is configured to mount said optical pickup, said disc rotation mechanism and said transfer mechanism thereon;
a disc tray, which is configured to conduct storing and taking out of said disc; and
a connector, which is configured to electrically connect between a circuit board for conducting driving control of said rotation mechanism and an external electronic apparatus, wherein
a projection portion is provided on a reverse surface of said disc tray, at a portion facing to said connector at a position when said disc tray is stored, to be inserted into a gap between periphery of said connector and said housing.

2. The optical disc apparatus, as is described in the claim 1, wherein
said projection portion is inserted into the gaps defined between an upper surface and a side surface of said connector and said housing.

3. The optical disc apparatus, as is described in the claim 1, wherein
said projection portion is inserted only into the gap defined between an upper surface and said housing.

4. The optical disc apparatus, as is described in the claim 1, wherein
said projection portion is inserted only into the gap defined between a side surface and said housing.

5. The optical disc apparatus, as is described in the claim 1, wherein
a cutout portion is provided penetrating to said disc tray at position facing to said connector, in position where said disc tray is stored.

6. The optical disc apparatus, as is described in the claim 5, wherein
a cutout surface defining said cutout portion is inclined with respect to a surface facing to said connector.

7. An electronic apparatus mounting the optical disc apparatus described in the claim 1 mentioned above.
